(19) United States
(12) Patent Application Publication
(10) Pub. No.: US 2023/0297693 A1
(43) Pub. Date: Sep. 21, 2023

(54) INFORMATION PROCESSING APPARATUS, INFORMATION PROCESSING METHOD, AND NON-TRANSITORY COMPUTER READABLE MEDIUM STORING PROGRAM

(71) Applicants: NEC Corporation, Tokyo (JP); UNIVERSITY OF HYOGO, Kobe-shi, Hyogo (JP)

(72) Inventors: Kazuhiko MINEMATSU, Tokyo (JP); Takanori ISOBE, Hyogo (JP); Kosei SAKAMOTO, Hyogo (JP)

(73) Assignees: NEC Corporation, Tokyo (JP); UNIVERSITY OF HYOGO, Kobe-shi, Hyogo (JP)

(21) Appl. No.: 18/024,195

(22) PCT Filed: Sep. 2, 2020
(86) PCT No.: PCT/JP2020/033183

§ 371 Date: Mar. 1, 2023

(51) Int. Cl. G06F 21/60; G06F 17/16; G06F 7/58

(52) U.S. Cl. CPC G06F 21/602; G06F 7/582; G06F 17/16

(57) ABSTRACT

An information processing apparatus includes an input receiving unit, a first permutation processing unit that repeats a first permutation process a times and outputs a first intermediate text, a second permutation processing unit that repeats a second permutation process b times and outputs a second intermediate text, and a termination processing unit that performs a termination process for outputting a ciphertext by using the second intermediate text as an input. The first permutation process is a permutation process in which an addition process, an S-box process, a bit permutation process, and a matrix multiplication process are successively performed. The second permutation process is a permutation process in which the addition process, the S-box process, a nibble permutation process, and the matrix multiplication process are successively performed. The termination process is a permutation process in which the S-box process and the addition process are successively performed.

### TECHNICAL FIELD

The present disclosure relates to an information processing apparatus, an information processing method, and a non-transitory computer readable medium storing a program.

### BACKGROUND ART

Regarding ordinary common key cryptography, there is an evaluation index called latency. This index refers to a time period from when processing is started to when the first output result is obtained, and it is desired that it be as small as possible. In particular, latency becomes problematic, for example, in the protection of a memory bus inside a computer, and in communication for which real-time processing is required, such as online games and control of drones. Therefore, it is desired that latency be small. Among these applications, the protection of memories has become particularly widespread. For example, in recent years, there are CPUs (Central Processing Units) that have functions of encrypting a memory and detecting tampering as typified by one disclosed in Non-patent Literature 1.

In the case of encryption, latency refers to a time period or an amount of processing that is required from when a plaintext composed of a plurality of blocks is input to when the first block of a ciphertext is output. It is possible to improve the amount of processing per unit time (i.e., the throughput) of the encryption process by performing processing in a parallel manner by hardware. On the other hand, performing processing in a parallel manner is not effective for reducing latency. To reduce latency, a full-unrolled implementation in which loop processes in the encryption process are unfolded is typically used. In this case, latency is determined according to the length of a critical path in the circuit for the full-unrolled implementation.

As an example of the encryption process of which one of the purposes is to reduce latency, Patent Literature 2 discloses a block cipher called “PRINCE”. The PRINCE is a type of lightweight 64-bit block cipher. However, while a relatively simple round function is repeated a large number of times in ordinary lightweight block cipher, the PRINCE uses a round function involving a relatively large number of processes and includes, as a contrivance, a keyless permutation-layer process in the middle of the encryption process. As a result, the PRINCE has succeeded in ensuring security with fewer rounds, and as a result has succeeded in reducing latency.

Further, lightweight block cipher called “Midori” disclosed in Non-patent Literature 3 includes two versions of block cipher, i.e., 64-bit block cipher and 128-bit block cipher. It was originally designed for an energy saving purpose, but since the number of rounds is relatively small, it is also excellent as low-latency cipher.

Further, QARMA disclosed in in Non-patent Literature 4 is lightweight tweakable block cipher and is low-latency cipher developed for encryption for a memory.

As another related technology, Non-patent Literature 5 discloses a GCM mode, which is a block cipher mode of operation. Further, Non-patent literature 6 discloses a highly-secure pseudorandom function (PRF: PseudoRandom Function).

### CITATION LIST

### Non Patent Literature

Non-Patent Literature 1: S. Gueron, “A Memory Encryption Engine Suitable for General Purpose Processors,” Cryptology ePrint Archive: Report 2016/204, February 2016
Non-Patent Literature 2: J. Borghoff et al., “PRINCE - A Low-latency Block Cipher for Pervasive Computing Applications” (Full version), Cryptology ePrint Archive: Report 2012/529, September 2012
Non-patent Literature 3: S. Banik et al., “Midori: A Block Cipher for Low Energy″(Extended Version), Cryptology ePrint Archive: Report 2015/1142, November 2015
Non-Patent Literature 4: R. Avanzi, “The QARMA Block Cipher Family: Almost MDS Matrices Over Rings With Zero Divisors, Nearly Symmetric Even-Mansour Constructions With Non-Involutory Central Rounds, and Search Heuristics for Low-Latency S-Boxes,” Cryptology ePrint Archive: Report 2016/444, May 2016
Non-Patent Literature 5: M. Dworkin, “Recommendation for Block Cipher Modes of Operation: Galois/Counter Mode (GCM) and GMAC”, NIST Special Publication 800-38D, November 2007
Non-Patent Literature 6: W. Dai et al., “Information-theoretic Indistinguishability via the Chi-squared Method,” Cryptology ePrint Archive: Report 2017/537, June 2017.

### SUMMARY OF INVENTION

### Technical Problem

Since the PRINCE is 64 bit block cipher, its input width (i.e., the number of bits of an input) is 64 bits. Therefore, in an ordinary block cipher mode of operation, in order to evade the so-called birthday attack, it is necessary to update the key every time roughly O(2^32) blocks have been processed. This fact poses a practical difficulty for an application in which a large amount of data is processed at a high speed, such as for the protection of a memory.

Although the latencies in the 128-bit input width version of the Midori (Midori-128) and the 128-bit input width version of the QARMA are small, they are not as small as the latency in the PRINCE partly because of their large block sizes.

Therefore, a cryptographic primitive having a 128-bit input width and small latency is considered to be important. In the case of 128-bit block cipher, the amount of data necessary for the aforementioned birthday attack increases to O(2^64) blocks, so that the security is significantly improved.

The present disclosure has been made to solve the above-described problem, and an object thereof is to provide an information processing apparatus, an information processing method, and a program capable of realizing an encryption process of which latency is small and the input width is large.

### Solution to Problem

An information processing apparatus according to a first aspect of the present disclosure includes:
input receiving means for receiving an input of a plaintext in which 128 bits are handled as one block;
first permutation processing means for repeating a first permutation process a times (where a is a predetermined integer) in which one block of the plaintext is used as a first input, and thereby outputting a first intermediate text;
second permutation processing means for repeating a second permutation process b times (where b is a predetermined integer) in which the first intermediate text is used as a first input, and thereby outputting a second intermediate text; and
termination processing means for performing a termination process for outputting a ciphertext by using the second intermediate text as an input, in which
   the first permutation process is a permutation process in which:
      an addition process for adding a round key and a round constant to the input;
      an S-box process for applying, for each nibble, a 4-bit S-box to the input, the 4-bit S-box being a nonlinear function of converting a 4-bit input into a 4-bit output;
      a bit permutation process for rearranging the input on a bit-by-bit basis; and
      a matrix multiplication process for dividing the input, at every four nibbles, into eight words, and applying a 4×4 Almost MDS matrix transformation to each of the words are successively performed,
   the second permutation process is a permutation process in which:
      the addition process;
      the S-box process;
      a nibble permutation process for rearranging the input on a nibble-by-nibble basis; and
      the matrix multiplication process are successively performed, and
   the termination process is a permutation process in which:
      the S-box process; and
      the addition process are successively performed.

An information processing method according to a second aspect of the present disclosure includes:
receiving an input of a plaintext in which 128 bits are handled as one block;
repeating a first permutation process a times (where a is a predetermined integer) in which one block of the plaintext is used as a first input, and thereby outputting a first intermediate text;
repeating a second permutation process b times (where b is a predetermined integer) in which the first intermediate text is used as a first input, and thereby outputting a second intermediate text; and
performing a termination process for outputting a ciphertext by using the second intermediate text as an input, in which
   the first permutation process is a permutation process in which:
      an addition process for adding a round key and a round constant to the input;
      an S-box process for applying, for each nibble, a 4-bit S-box to the input, the 4-bit S-box being a nonlinear function of converting a 4-bit input into a 4-bit output;
      a bit permutation process for rearranging the input on a bit-by-bit basis; and
      a matrix multiplication process for dividing the input, at every four nibbles, into eight words, and applying a 4×4 Almost MDS matrix transformation to each of the words are successively performed,
   the second permutation process is a permutation process in which:
      the addition process;
      the S-box process;
      a nibble permutation process for rearranging the input on a nibble-by-nibble basis; and
      the matrix multiplication process are successively performed, and
   the termination process is a permutation process in which:
      the S-box process; and
      the addition process are successively performed.

A program according to a third aspect of the present disclosure causes a computer to perform:
an input receiving step of receiving an input of a plaintext in which 128 bits are handled as one block;
a first permutation processing step of repeating a first permutation process a times (where a is a predetermined integer) in which one block of the plaintext is used as a first input, and thereby outputting a first intermediate text;
a second permutation processing step of repeating a second permutation process b times (where b is a predetermined integer) in which the first intermediate text is used as a first input, and thereby outputting a second intermediate text; and
a termination processing step of performing a termination process for outputting a ciphertext by using the second intermediate text as an input, in which
   the first permutation process is a permutation process in which:
      an addition process for adding a round key and a round constant to the input;
      an S-box process for applying, for each nibble, a 4-bit S-box to the input, the 4-bit S-box being a nonlinear function of converting a 4-bit input into a 4-bit output;
      a bit permutation process for rearranging the input on a bit-by-bit basis; and
      a matrix multiplication process for dividing the input, at every four nibbles, into eight words, and applying a 4×4 Almost MDS matrix transformation to each of the words are successively performed,
   the second permutation process is a permutation process in which:
      the addition process;
      the S-box process;
      a nibble permutation process for rearranging the input on a nibble-by-nibble basis; and
      the matrix multiplication process are successively performed, and
   the termination process is a permutation process in which:
      the S-box process; and
      the addition process are successively performed.

### Advantageous Effects of Invention

According to the present disclosure, it is possible to provide an information processing apparatus, an information processing method, and a program capable of realizing an encryption process of which latency is small and the input width is large.

### BRIEF DESCRIPTION OF DRAWINGS

FIG. 1 is a block diagram showing an example of a configuration of an information processing apparatus according to an outline of an example embodiment;

FIG. 2 is a schematic diagram showing an example of a configuration of an information processing apparatus according to a first example embodiment;

FIG. 3 is a schematic diagram for explaining a first condition;

FIG. 4 is a schematic diagram for explaining a second condition;

FIG. 5 is a flowchart showing an example of a flow of operations performed by the information processing apparatus according to the first example embodiment;

FIG. 6 is a schematic diagram showing a round function in a first permutation process (except for a process for adding a round key and a round constant to an input);

FIG. 7 is a schematic diagram showing a round function in a second permutation process (except for a process for adding a round key and a round constant to an input);

FIG. 8 is a schematic diagram showing a round function in a comparative example (except for a process for adding a round key and a round constant to an input);

FIG. 9 is a schematic diagram showing an example of a configuration of an information processing apparatus according to a second example embodiment;

FIG. 10 is a flowchart showing an example of a flow of operations performed by the information processing apparatus according to the second example embodiment; and

FIG. 11 is a block diagram showing an example of a configuration of a computer.

### EXAMPLE EMBODIMENT

### Outline of Example Embodiment

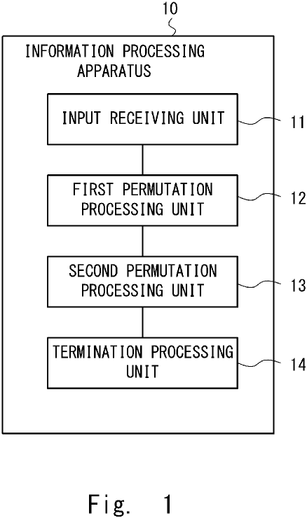

Prior to describing details of an example embodiment, firstly, an outline of the example embodiment will be described. FIG. 1 is a block diagram showing an example of a configuration of an information processing apparatus 10 according to an outline of an example embodiment. As shown in FIG. 1, an information processing apparatus 10 includes an input receiving unit 11, a first permutation processing unit 12, a second permutation processing unit 13, and a termination processing unit 14.

The input receiving unit 11 receives an input of a plaintext in which 128 bits are handled as one block. The first permutation processing unit 12 repeats a first permutation process a times in which one block of the plaintext received by the input receiving unit 11 is used as the first input, and thereby outputs a first intermediate text. Note that a is an arbitrarily-determined predetermined integer. The second permutation processing unit 13 repeats a second permutation process b times in which the first intermediate text output from the first permutation processing unit 12 is used as the first input, and thereby outputs a second intermediate text. Note that b is an arbitrarily-determined predetermined integer. The termination processing unit 14 performs a termination process for outputting a ciphertext by using the second intermediate text output from the second permutation processing unit 13 as an input.

Note that the above-described first permutation process is a permutation process in which an addition process, an S-box process, a bit permutation process, and a matrix multiplication process are successively performed. More concrete descriptions of these processes are given below. The addition process is a process for adding a round key and a round constant to an input. The S-box process is a process for applying, for each nibble, a 4-bit S-box to the input. Note that the 4-bit S-box is a nonlinear function of converting a 4-bit input into a 4-bit output. The bit permutation process is a process for rearranging the input on a bit-by-bit basis. The matrix multiplication process is a process for dividing the input, at every four nibbles, into eight words (i.e., dividing the input into eight words each of which contains four nibbles), and applying a 4×4 Almost MDS matrix transformation to each of the words.

Further, the above-described second permutation process is a permutation process in which an addition process, an S-box process, a nibble permutation process, and a matrix multiplication process are successively performed. The addition process, the S-box process, and the matrix multiplication process performed in the second permutation process are similar to those performed in the first permutation process. In contrast to the first permutation process, the nibble permutation process, instead of the bit permutation process, is performed in the second permutation process. The nibble permutation process is a process for rearranging an input by a nibble-by-nibble basis.

Further, the above-described termination process is a permutation process in which an S-box process and an addition process are successively performed. The S-box process and the addition process performed in the termination process are similar to those performed in the first permutation process.

By the information processing apparatus 10 having the above-described configuration, it is possible to realize an encryption process of which latency is small and the input width (i.e., the number of bits of an input) is large.

### Next, Details of an Example Embodiment Will Be Described. <First Example Embodiment>

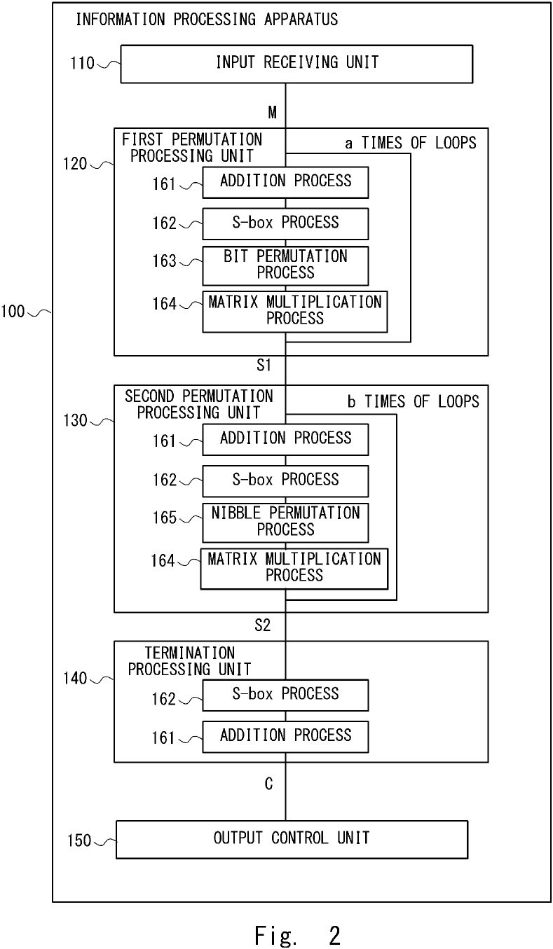

FIG. 2 is a schematic diagram showing an example of a configuration of an information processing apparatus 100 according to a first example embodiment. As shown in FIG. 2, the information processing apparatus 100 includes an input receiving unit 110, a first permutation processing unit 120, a second permutation processing unit 130, a termination processing unit 140, and an output control unit 150. Note that input receiving unit 110, the first permutation processing unit 120, the second permutation processing unit 130, and the termination processing unit 140 correspond to the input receiving unit 11, the first permutation processing unit 12, the second permutation processing unit 13, and the termination processing unit 14, respectively, shown in FIG. 1. The information processing apparatus 100 according to this example embodiment is also referred to as a block encryption apparatus. Further, in this example embodiment, the length of one block is 128 bits. Therefore, the information processing apparatus 100 is a block encryption apparatus having an input width of 128 bits.

The input receiving unit 110 is a hardware circuit that receives an input for the information processing apparatus 100. The input receiving unit 110 receives, for example, data entered through an input device such as a keyboard. In this example embodiment, the input receiving unit 110 receives an input of a plaintext M. The input receiving unit 110 receives an input of a plaintext in which 128 bits are handled as one block.

The first permutation processing unit 120 performs processing in which a block is handled as the unit of processing. The first permutation processing unit 120 is a hardware circuit that repeats a first permutation process a times in which one block of the plaintext received by the input receiving unit 110 is used as the first input, and thereby outputs a first intermediate text S1. In each of the second-time and subsequent first permutation processes, which are repeated, the result of the previous (i.e., the last) first permutation process is used as the input for the current first permutation process. Note that the number a, which defines the number of repetitions, is determined in advance.

Specifically, as the first permutation process, the first permutation processing unit 120 performs first an addition process 161, then an S-box process 162, then a bit permutation process 163, and lastly a matrix multiplication process 164.

The addition process 161 is a process for adding a round key and a round constant to an input. Note that an input of the addition process 161 is 128-bit data. The addition process 161 will be described hereinafter in detail. In the addition process 161, the below-described process is performed by using a 128-bit input X, a private key K, and a loop counter i. Firstly, in the addition process 161, a round key K_i, which is a value determined according to the private key K and the counter i, is derived, and a round constant c_i, which is a value determined according to the counter i, is derived. The length of the round key K_i calculated from the private key K and the counter i, and that of the round constant c_i calculated from the counter i are both 128 bits at the maximum. Further, when the number of bits is less than 128 bits, the length is adjusted to 128 bits by zero padding. The private key K may be one that is received by the input receiving unit 110, or predetermined key data stored in advance in the information processing apparatus 100 may be used as the private key K. The private key K is, for example, an arbitrary string of 128 or 256 bits, but the number of bits of the private key K is not limited to these numbers. The counter i is a counter indicating the number of loops, i.e., the number of repetitions of the process. When the addition process 161 is performed as the first permutation process, the counter i is expressed as i = 1, 2, ..., and a. Note that, as will be described later, the addition process 161 may also be performed as the second permutation process, and in this case, the counter i is expressed as i = 1, 2, ..., and b.

In this example embodiment, for example, the round key K_i and the round constant c_i are derived as described below. In this example embodiment, the private key K is 128 bits, and the round key K_i is 64 bits in the first half of the private key K when the counter i is an even number, and is the 64 bits in the second half (i.e., the latter half) thereof when the counter i is an odd number. Further, the round constant c_i is 4 bits that are extracted from the bit representation of the circular constant (i.e., pi) (3.14159 . . . ) according to the value of the counter i. However, the above-described values and the like are merely examples, and the round key K_i and the round constant c_i may be derived by other deriving methods.

Then, in the addition process 161, as the next process, a process for adding the round constant c_i and the round key K_i to the input X is performed. Note that this addition is, for example, an exclusive disjunction (or exclusive or), but may be an arithmetic addition or the like. In the addition process 161, a 128-bit data string is output as the result of the addition.

The S-box process 162 is a process for applying 4-bit S-boxes, which are 4-bit nonlinear functions, to the input in a parallel manner. Since the input is 128 bits in this example embodiment, 32 4-bit S-boxes are applied in parallel in the S-box process 162. As described above, in the S-box process 162, for each nibble, a 4-bit S-box is applied to the input. Then, a 128-bit data string is output in the S-box process 162. The S-box needs to fully diffuse bits over the 4-bit range. That is, when the 4-bit input of the S-box is represented by x and the 4-bit output of the S-box is represented by y, it is required that each bit of y depend on all the bits of x. In other words, when x[i] represents an i-th bit of x and y[i] represents an i-th bit of y, it is required that y[i] be expressed by a logical expression using all of x[1], x[2], x[3] and x[4]. An arbitrary S-box can be used as the above-described S-box. However, as an example, Sb₁ in the Midori, which is defined as permutations as shown in the below-shown table, may be used. Note that, in the below-shown table, an input x and an output Sb₁(x) are expressed in hexadecimal.

TABLE 1

| | | | | | | | | | | | | | | | | |
|---|---|---|---|---|---|---|---|---|---|---|---|---|---|---|---|---|
| X | 0 | 1 | 2 | 3 | 4 | 5 | 6 | 7 | 8 | 9 | a | b | c | d | e | f |
| Sb₁(x) | 1 | 0 | 5 | 3 | e | 2 | f | 7 | d | a | 9 | b | c | 8 | 4 | 6 |

The bit permutation process 163 is a process for rearranging an input on a bit-by-bit basis, in which an input 128-bit data string (i.e., a 32-nibble data string) is rearranged, and a 128-bit data string is thereby output. It can be shown that, assuming that the bit permutation is optimal in terms of the diffusing performance, when a loop composed of the addition process 161, the S-box process 162, the bit permutation process 163, and the matrix multiplication process 164 is defined as one round, 128-bit data is fully diffused in 2.5 rounds. Note that 2.5 rounds means performing the processing up to the middle of the third round, more specifically, up to the addition process 161 and the S-box process 162 in the third round. Therefore, the number a of repetitions (hereinafter also referred to as the repetition number a) in the first permutation process may be three. To ensure the full diffusion by 2.5 rounds, it is sufficient if the below-shown two conditions are satisfied. Here, the input 32 nibbles are expressed as X(1), . . ., and X(32) and the output 32 nibbles are expressed as Y(1), ..., and Y(32). Further, the output is divided at every four nibbles and is expressed as W(1) = [Y(1), Y(2), Y(3), Y(4)], W(2) = [Y(5), Y(6), Y(7), Y(8)], . . ., and W(8) = [Y(29), Y(30), Y(31), Y(32)]. Further, nibbles to which four bits B(i,1), B(i,2), B(i,3) and B(i,4) of the input X(i) are mapped are represented by Y(a), Y(b), Y(c) and Y(d), respectively (where each of a, b, c and d is an integer no smaller than 1 and no greater 32). Further, 12 nibbles that are obtained by excluding Y(a), Y(b), Y(c) and Y(d) from W(j) to which the aforementioned four nibbles (i.e., Y(a), Y(b), Y(c) and Y(d)) belong are represented by Y(j[1]), Y(j[2]), ..., and Y(j[12]) (where each of j[1], j[2] and j[12] is an integer no smaller than 1 and no greater 32).

The bit permutation process 163 for ensuring the full diffusion by 2.5 rounds is a process for rearranging bits so that the below-shown first condition and the second condition are satisfied.

### First Condition

For each i = 1, ..., and 32, all the four bits B(i,1), B(i,2), B(i,3) and B(i,4) of an input X(i) should be mapped to different W(j) (j = 1, . . ., and 8).

### Second Condition

At least two nibbles should be covered in each of W(1), . . ., and W(8) by the mapping of the 12 nibbles X(j[1]), X(j[2]), ..., and X(j[12]) of the input, in which the positions of the nibbles in the inputs X(1), . . ., and X(32) correspond to the positions of Y(j[1]), Y(j[2]), . . ., and Y(j[12]) in Y(1), ..., and Y(32).

That is, when the 12 nibbles X(j[1]), X(j[2]), ..., and X(j[12]) of the input are mapped, in each of W(1), . . ., and W(8), at least two of the four nibbles Y(k), Y(k+1), Y(k+2) and Y(k+3) (k = 1, 5, 9, 13, 17, 21, 25 and 29) constituting W(j) (j = 1, . . ., and 8) are selected as the destinations of the mapping.

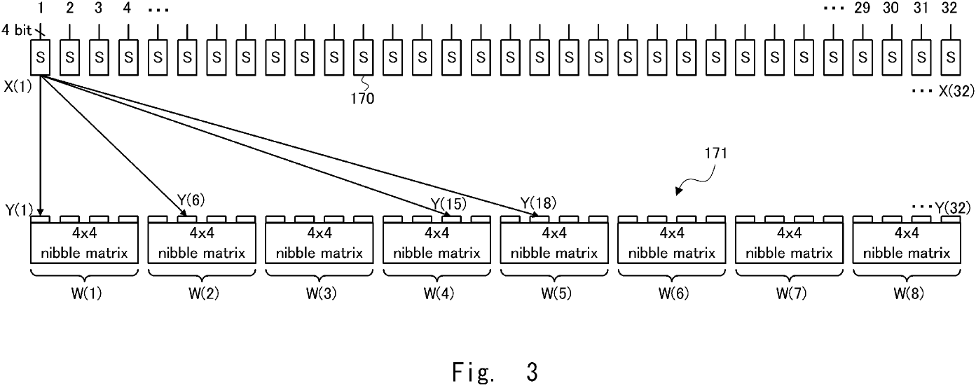

FIG. 3 is a schematic diagram for explaining the first condition. In FIG. 3, 32 S-boxes 170, which are applied in parallel in the S-box process 162, and eight matrices 171, which are applied in parallel in a matrix multiplication process 164 (which will be described later), are shown, and the bit permutation process 163 is represented by arrows extending from the output of the S-box 170 to inputs of the matrices 171. Note that the outputs of a total of 32 nibbles by respective S-boxes 170 correspond to the inputs X(1), . . ., and X(32) of the 32 nibbles in the bit permutation process 163. Further, the inputs of a total of 32 nibbles in respective matrices 171 correspond to the output Y(1), . . ., and Y(32) of the 32 nibbles in the bit permutation process 163.

As described above, in the rearrangement that satisfies the first condition, the four output bits of each S-box 170 are mapped to inputs of different matrices 171. In FIG. 3, the destinations of the mapping of only the four bits (X(1)) output from the leftmost S-box 170 are shown in order to prevent the drawing from becoming difficult to be understood. In this example, the first bit B(1,1) of X(1) is mapped to Y(1) included in W(1); the second bit B(1,2) of X(1) is mapped to Y(6) included in W(2); the third bit B(1,3) of X(1) is mapped to Y(15) included in W(4); and the fourth bit B(1,4) of X(1) is mapped to Y(18) included in W(5).

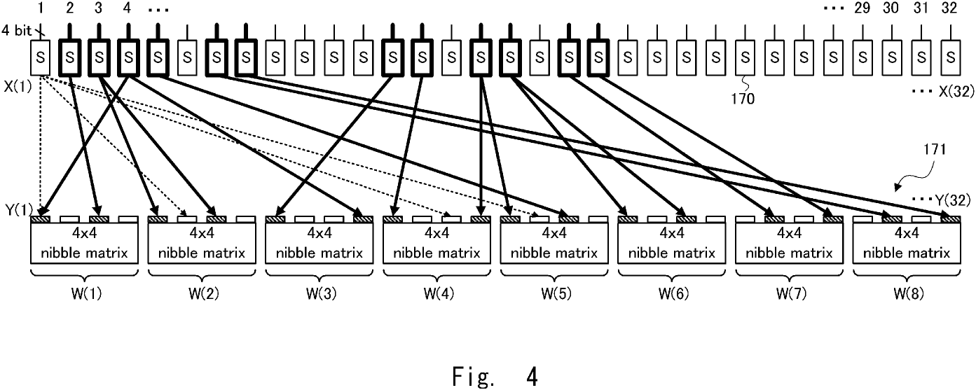

FIG. 4 is a schematic diagram for explaining the second condition. In FIG. 4, similarly to FIG. 3, 32 S-boxes 170, which are applied in parallel in the S-box process 162, and eight matrices 171, which are applied in parallel in the matrix multiplication process 164 (which will be described later), are shown. Further, the bit permutation process 163 is represented by arrows extending from the output of the S-box 170 to inputs of the matrices 171.

As described above, in the rearranging that satisfies the second condition, at least two nibbles are covered by the mapping of the 12 nibbles X(j[1]), X(j[2]), ..., and X(j[12]) of the input in each of W(1), ..., and W(8). Note that the 12 nibbles X(j[1]), X(j[2]), . . ., and X(j[12]) are X(i) for which the positions of the nibbles in the inputs X(1), . . ., and X(32) correspond to the positions of Y(j[1]), Y(j[2]), ..., and Y(j[12]) in Y(1), ..., and Y(32). Further, as described above, Y(j[1]), Y(j[2]), . . ., and Y(j[12]) are 12 nibbles that are obtained by excluding Y(a), Y(b), Y(c) and Y(d) from W(j) to which the nibbles Y(a), Y(b), Y(c) and Y(d) to which the four bits B(i,1), B(i,2), B(i,3) and B(i,4) of the input X(i) are mapped belong.

FIG. 4 shows an example case under the assumption that four bits B(1,1), B(1,2), B(1,3) and B(1,4) of an input X(1) are the four bits B(i,1), B(i,2), B(i,3) and B(i,4) of the input X(i). In the example shown in FIG. 4, Y(a), Y(b), Y(c) and Y(d) are nibbles at the destinations of mapping indicated by dashed arrows, and specifically are Y(1), Y(6), Y(15) and Y(18). Further, Y(j[1]), Y(j[2]), ..., and Y(j[12]) are 12 nibbles that are obtained by excluding Y(1), Y(6), Y(15) and Y(18) from W(j) to which nibbles Y(1), Y(6), Y(15) and Y(18) belong. Since Y(1), Y(6), Y(15) and Y(18) belong to W(1), W(2), W(4) and W(5), respectively, Y(j[1]), Y(j[2]), . . ., and Y(j[12]) are specifically Y(2), Y(3), Y(4), Y(5), Y(7), Y(8), Y(13), Y(14), Y(16), Y(17), Y(19) and Y(20). Therefore, the 12 nibbles X(j[1]), X(j[2]), . . ., and X(j[12]) are specifically X(2), X(3), X(4), X(5), X(7), X(8), X(13), X(14), X(16), X(17), X(19) and X(20).

Therefore, to satisfy the second condition, as shown in FIG. 4, it is necessary that at least two nibbles need to be covered in each of W(1), . . ., and W(8) by the mapping of the input 12 nibbles X(2), X(3), X(4), X(5), X(7), X(8), X(13), X(14), X(16), X(17), X(19) and X(20). Note that, in FIG. 4, the mapping of X(2), X(3), X(4), X(5), X(7), X(8), X(13), X(14), X(16), X(17), X(19) and X(20) are indicated by bold arrows, but the mapping of only some of the bits is shown in order to prevent the drawing from becoming difficult to be understood. That is, for example, as the mapping of X(2) (the output of the second S-box from the left), there is specifically mapping of each of the four bits of X(2), but only one of them is shown in FIG. 4. In the example shown in FIG. 4, among the four Y(1), Y(2), Y(3) and Y(4) constituting W(1), at least Y(1) and Y(3) are selected as the destinations of the mapping by the mapping of X(i) (I = 2, 3, 4, 5, 7, 8, 13, 14, 16, 17, 19 and 20). That is, at least two of the four Y(1), Y(2), Y(3) and Y(4) constituting W(1) are selected as the destinations of the mapping. Similarly, as shown in FIG. 4, for each of W(2), W(3), W(4), W(5), W(6), W(7) and W(8), at least two of the four Y(k), Y(k+1), Y(k+2) and Y(k+3) constituting W(j) are selected as the destinations of the mapping.

The matrix multiplication process 164 is a process for dividing an input, at every four nibbles, into eight words, and applying a 4×4 Almost MDS matrix transformation to each of the words, and thereby outputting a data string of 128 bits in total. In the matrix multiplication process 164 performed as the first permutation process, an Almost MDS matrix transformation is performed for each of the words W(1), . . ., and W(8) obtained by dividing the above-described output Y(1), . . ., and Y(32) obtained in the bit permutation process 163 into eight words. Note that, as will be described later, the matrix multiplication process 164 may also be performed as the second permutation process, and in this case, an Almost MDS matrix transformation is performed for each of the eight words obtained by dividing the output obtained in the nibble permutation process 165 at every four nibbles.

When the input to the Almost MDS matrix is A = (a_1, a_2, a_3, a_4) (each a_i is a nibble), the result (b_1, b_2, b_3, b_4) (each b_i is a nibble) of the application of the Almost MDS matrix is obtained as the product of the Almost MDS matrix and the transposed vector of A. The Almost MDS matrix will be described hereinafter. For any two different inputs A = (a_1, a_2, a_3, a_4) and A′ = (a′_1, a′_2, a′_3, a′_4), the Hamming weight of the difference A xor A′ (xor indicates exclusive OR of each pair of elements) is represented by d_A. Further, the output obtained by applying a matrix Mb to each of them is expressed as B = (b_1, b_2, b_3, b_4) and B′ = (b′_1, b′_2, b′_3, b′_4), and similarly, the Hamming weight of the difference B xor B′ is represented by d_B. Then, when d_A+d_B is always equal to or greater than four, the matrix Mb is referred to as the Almost MDS matrix.

For example, the below-shown matrix is the Almost MDS matrix.

$$\left(\begin{matrix}0 & 1 & 1 & 1 \\ 1 & 0 & 1 & 1 \\ 1 & 1 & 0 & 1 \\ 1 & 1 & 1 & 0\end{matrix}\right) \qquad \text{[Expression 1]}$$

When the above-shown matrix is used, the output B = (b_1, b_2, b_3, b_4) corresponding to the input A = (a_1, a_2, a_3, a_4) is expressed as shown below.

$$\text{b\_1 =} \text{a\_2+a\_3+a\_4}$$

$$\text{b\_2 = a\_1+a\_3+a\_4}$$

$$\text{b\_3 = a\_1+a\_2+a\_4}$$

$$\text{b\_4 = a\_1+a\_2+a\_3}$$

Each of the processes performed in the first permutation process has been described above. As described above, the first permutation processing unit 120 repeats the first permutation process a times and outputs the first intermediate text S1. In the first round of the processes, the addition process 161 is performed for one block of the plaintext received by the input receiving unit 110. Then, the S-box process 162 is performed for the result of the addition process 161, and the bit permutation process 163 is performed for the result of the S-box process 162. Further, the matrix multiplication process 164 is performed for the result of the bit permutation process 163. With these processes, the first round of the first permutation process is completed. Then, the result of the matrix multiplication process 164 in the first round of the first permutation process is used as an input for the addition process 161 in the second round of the first permutation process. Then, the S-box process 162 in the second round of the first permutation process is performed for the result of the addition process 161 in the second round of the first permutation process. After that, processes are performed in a similar manner until the first permutation process is repeated a times. When the first permutation processing unit 120 repeats the first permutation process a times, it outputs the final processing result to the second permutation processing unit 130 as the first intermediate text S1.

Next, the second permutation processing unit 130 will be described. The second permutation processing unit 130 is a hardware circuit that repeats a second permutation process b times in which the first intermediate text S1, i.e., the 128-bit data string output from the first permutation processing unit 120, is used as the first input, and thereby outputs a second intermediate text S2. In each of the second-time and subsequent second permutation processes, which are repeated, the result of the previous (i.e., the last) second permutation process is used as the input for the current second permutation process. Note that the number b, which defines the number of repetitions, is determined in advance.

Specifically, as the second permutation process, the second permutation processing unit 130 performs first an addition process 161, then an S-box process 162, then a nibble permutation process 165, and lastly a matrix multiplication process 164. The addition process 161, the S-box process 162, and the matrix multiplication process 164, all of which are performed as parts of the second permutation process, are similar to these performed as parts of the first permutation process, and therefore their descriptions are omitted.

The nibble permutation process 165 is a process for rearranging an input on a nibble-by-nibble basis, in which an input data string composed of 32 nibbles (i.e., 128 bits) are rearranged, and a data string composed of 32 nibbles (i.e., 128 bits) is thereby output. In this example embodiment, as the nibble permutation process 165, processes are performed so that the number of Active S-boxes reaches a predetermined value in a small number of rounds. Specifically, the predetermined value is a value with which the product of the exponent of the maximum differential probability of the S-box and the number of Active S-boxes becomes -128. In the case of a 4-bit S-box, since the maximum differential probability of the S-box is 2^-2, the predetermined value is specifically 64.

For example, the nibble permutation process 165 ensures the number of Active S-boxes (hereinafter also referred to as the Active S-box number), which is 64, in five rounds. Therefore, the repetition number b of the second permutation process may be five. For example, in the below-shown nibble permutation process 165, the Active S-box number, which is 64, is ensured in five rounds. Note that it is assumed that indices from 0 to 31 are sequentially assigned to every four bits of the input bit string, and the rearrangement in the nibble permutation process 165 is expressed by the change of the arrangement of these indices. For example, the nibble permutation process 165 is a rearrangement process in which the arrangement (i.e., the order) of indexes when they are input is (0, 1, . . ., 31) and the arrangement of indexes when they are output is (10, 27, 5, 1, 30, 23, 16, 13, 21, 31, 6, 14, 0, 25, 11, 18, 15, 28, 19, 24, 7, 8, 22, 3, 4, 29, 9, 2, 26, 20, 12, 17). Further, in another example, the nibble permutation process 165 is a rearrangement process in which the arrangement (i.e., the order) of indexes when they are input is (0, 1, . . ., 31) and the arrangement of indexes when they are output is (26, 13, 7, 11, 29, 0, 17, 21, 23, 5, 18, 25, 12, 10, 28, 2, 14, 19, 24, 22, 1, 8, 4, 31, 15, 6, 27, 9, 16, 30, 20, 3).

As described above, in this example embodiment, the nibble permutation process 165 is a process in which the number of rounds (the number of repetitions of the processes) of the nibble permutation process 165 necessary for increasing the Active S-box number to a predetermined number or greater satisfies a predetermined condition(s).

The processes performed in the second permutation process has been described above. As described above, the second permutation processing unit 130 repeats the second permutation process b times and outputs the second intermediate text S2. In the first round of the processes, the addition process 161 is performed for the data string output from the first permutation processing unit 120. Then, the S-box process 162 is performed for the result of the addition process 161, and the nibble permutation process 165 is performed for the result of the S-box process 162. Further, the matrix multiplication process 164 is performed for the result of the nibble permutation process 165. With these processes, the first round of the second permutation process is completed. Then, the result of the matrix multiplication process 164 in the first round of the second permutation process is used as an input of the addition process 161 in the second round of the second permutation process. Then, the S-box process 162 in the second round of the second permutation process is performed for the result of the addition process 161 in the second round of the second permutation process. After that, processes are performed in a similar manner until the second permutation process is repeated b times. When the second permutation processing unit 130 repeats the second permutation process b times, it outputs the final processing result to the termination processing unit 140 as the second intermediate text S2.

Next, the termination processing unit 140 will be described. The termination processing unit 140 is a hardware circuit that performs a termination process for outputting a ciphertext C in which the second intermediate text S2, i.e., the 128-bit data string output from the second permutation processing unit 130, is used as an input.

Specifically, as the termination process, the termination processing unit 140 performs first the S-box process 162 and then the addition process 161. That is, the termination processing unit 140 first performs the S-box process 162 for the second intermediate text S2 output from the second permutation processing unit 130, and then performs the addition process 161 for the result of the S-box process 162. Then, the termination processing unit 140 outputs the result of the addition process 161 as a ciphertext C.

The output control unit 150 is a hardware circuit that performs control for outputting the result of the processing performed by the termination processing unit 140 to an output device such as a display. That is, the output control unit 150 performs control for outputting the ciphertext C to the output device.

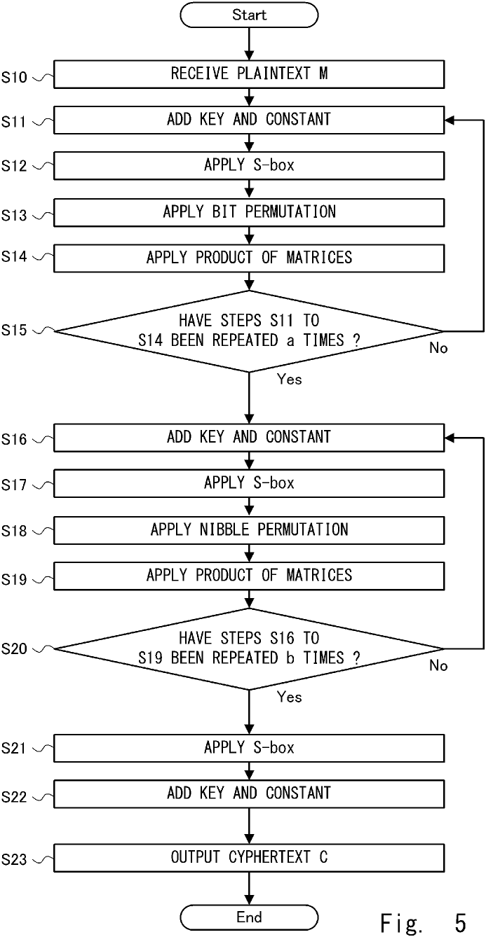

FIG. 5 is a flowchart showing an example of a flow of operations performed by the information processing apparatus 100. The flow of operations performed by the information processing apparatus 100 will be described hereinafter with reference to FIG. 5.

In a step S10, the input receiving unit 110 receives an input of a plaintext M.

Next, in a step S11, the first permutation processing unit 120 performs the addition process 161.

Next, in a step S12, the first permutation processing unit 120 performs the S-box process 162.

Next, in a step S13, the first permutation processing unit 120 performs the bit permutation process 163.

Next, in a step S14, the first permutation processing unit 120 performs the matrix multiplication process 164.

Next, in a step S15, the first permutation processing unit 120 determines whether or not the series of processes from the step S11 to the step S14 has been repeated a times. When the series of processes has not been repeated a times, the first permutation processing unit 120 repeats the series of processes from the step S11 to the step S14 again. On the other hand, when the series of processes has been repeated a times, a step S16 is performed. Note that the number a is, for example, three.

In the step S16, the second permutation processing unit 130 performs the addition process 161.

Next, in a step S17, the second permutation processing unit 130 performs the S-box process 162.

Next, in a step S18, the second permutation processing unit 130 performs the nibble permutation process 165.

Next, in a step S19, the second permutation processing unit 130 performs the matrix multiplication process 164.

Next, in a step S20, the second permutation processing unit 130 determines whether or not the series of processes from the step S16 to the step S19 has been repeated b times. When the series of processes has not been repeated b times, the second permutation processing unit 130 repeats the series of processes from the step S16 to the step S19 again. On the other hand, when the series of processes has been repeated b times, a step S21 is performed. Note that the number b is, for example, five.

In the step S21, the termination processing unit 140 performs the S-box process 162.

Next, in a step S22, the termination processing unit 140 performs the addition process 161.

Lastly, in a step S23, the output control unit 150 outputs the 128-bit string obtained in the step S22 to a display or the like as the ciphertext C. Note that, regarding the numbers of repetitions, the number a is three (a=3) and the number b is five (b=5) in the above-described example. However, the numbers of repetitions are not limited to these numbers. For example, the number a may be greater than three and the number b may be greater than five in order to improve the security. For example, the number a may be four (a=4) and the number b may be seven (b=7)

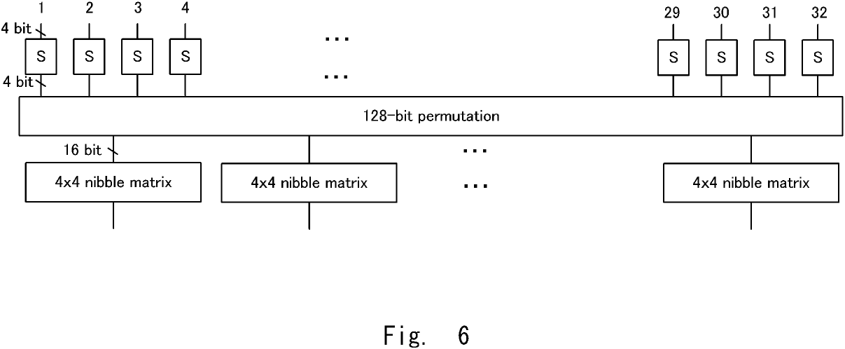

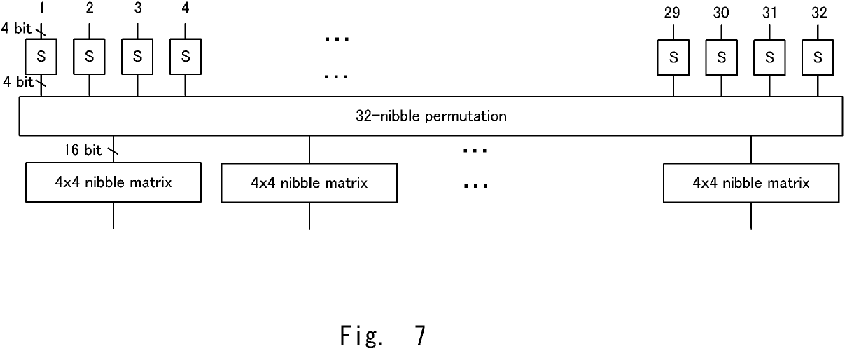

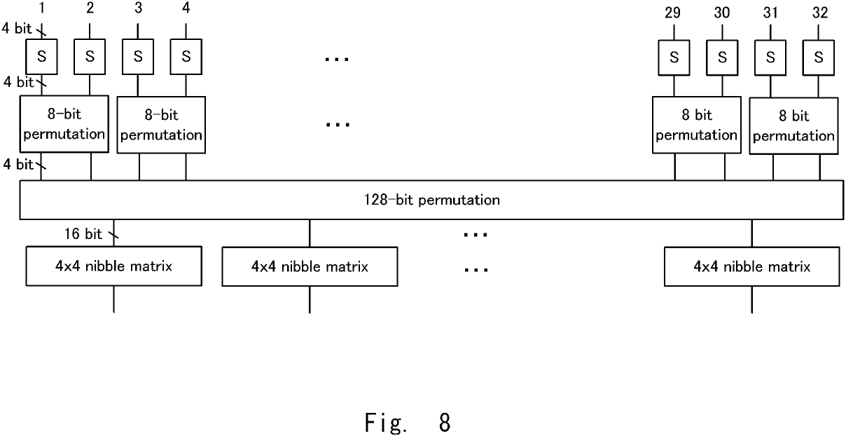

Next, effects of this example embodiment will be described. According to this example embodiment, it is possible to realize an encryption process of which the input width (i.e., the number of bits of an input) is 128 bits and latency is small. The round function in this example embodiment is based on the permutation network structure (Substitution-Permutation Network, SPN) using an Almost MDS matrix introduced by the Midori. However, unlike the Midori, the example embodiment uses a plurality of different linear layers. Specifically, bit permutation is used in the rounds in the first half (i.e., in the first permutation process) (see FIG. 6), and nibble permutation is used in the rounds in the second half (i.e., the latter half) (i.e., in the second permutation process) (see FIG. 7). Note that FIG. 6 is a schematic diagram showing the round function in the first permutation process (except for a process for adding a round key and a round constant to an input). Further, FIG. 7 is a schematic diagram showing the round function in the second permutation process (except for a process for adding a round key and a round constant to an input). Although bit permutation and nibble permutation are also used in the Midori-128, the Midori differs from the example embodiment because both of them are used in one round (i.e., in the same sound) in the Midori. Further, the bit permutation in the Midori-128 is used while arranging two 4-bit S-boxes side by side so that they substantially function as a 8-bit S-box. Therefore, the bit permutation in the Midori-128 is implemented by arranging 8-bit input/output bit permutations side by side (see FIG. 8). Note that FIG. 8 is a schematic diagram showing the round function in the Midori (except for a process for adding a round key and a round constant to an input). In contrast to this, the bit permutation in the example embodiment is performed in order to stir the whole 128 bits. The reason why the bit permutation is used in the rounds in the first half in the example embodiment is to ensure the full diffusion, which is important in the evaluation (or the assessment) of the security of cipher in a small number of rounds, i.e., to ensure that any change in the input data spreads throughout the whole output in a small number of rounds. The bit permutation divide data more finely than in the nibble permutation, which can improve the diffusing performance. When a series of processes including the addition process 161, the S-box process 162, the bit permutation process 163, and the matrix multiplication process 164 is defined as one round, any bit permutation that satisfies the above-described first and second conditions can ensure the full diffusion in 2.5 rounds. Note that 2.5 rounds means performing the processes up to the middle of the third round, more specifically, up to the addition process 161 and the S-box process 162 in the third round. In contrast, when only the nibble permutation is used instead of the bit permutation, at least four rounds are required to ensure the full diffusion. In the case of the Midori-128, bit permutation and nibble permutation are combined as described above. However, the Midori-128 requires three rounds for the full diffusion because the spread of the change in the bit permutation is small. Further, to satisfy the evaluation condition such as the condition for the Active S-box, the Midori-128 ultimately requires 20 rounds. In contrast, in the example embodiment, for example, when a = 4 and b = 7, only a total of 12 (=4+7+1) rounds are performed even when the termination process is counted as one round. Therefore, according to this example embodiment, an encryption process of which the input width is 128 bits and latency is smaller than that in the Midori-128 is provided.

Note that the reason why the nibble permutation is used in the rounds in the second half (i.e., in the second permutation process) in this example embodiment is to ensure the advantage in the number of Active S-boxes, which is a typical security evaluation index. The number of Active S-boxes reflects the security against differential cryptanalysis which is an important cryptographic analysis technique. It can be said that when it can be shown that the minimum value of the Active S-box number is equal to or greater than a predetermined value for a given pair of different inputs in given cipher, that cipher is sufficiently resistant to differential cryptanalysis. In general, since the granularity of bit permutation is fine, it is difficult to precisely derive the minimum value of the Active S-box number. As a result, the number of rounds required to ensure that the minimum value of the Active S-box number is equal to or greater than a predetermined value increases. Therefore, by the configuration according to this example embodiment in which bit permutation is used in the rounds in the first half, and the permutation is changed to nibble permutation after the full diffusion, it is possible to ensure the security in a small number of rounds. Note that, in general, the implementation of low-latency cipher is full-unroll implementation. Therefore, the fact that the configuration is changed between the rounds in the first half (in the first permutation process) and the rounds in the second half (in the second permutation process) does not pose any significant problem in the hardware implementation.

### Second Example Embodiment

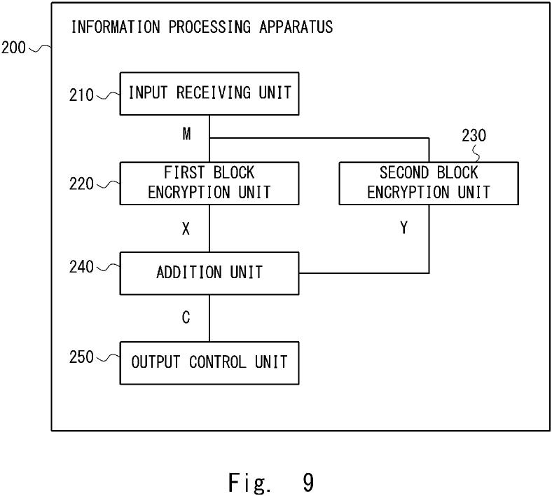

Next, a second example embodiment will be described. FIG. 9 is a schematic diagram showing an example of a configuration of an information processing apparatus 200 according to the second example embodiment. As shown in FIG. 9, the information processing apparatus 200 includes an input receiving unit 210, a first block encryption unit 220, a second block encryption unit 230, an addition unit 240, and an output control unit 250. Further, the information processing apparatus 200 generates a pseudorandom number by using the encryption process described in the first example embodiment. The information processing apparatus 200 according to this example embodiment is also referred to as a pseudorandom function apparatus.

The input receiving unit 210 is a hardware circuit that performs processes similar to those performed by the input receiving unit 110. That is, the input receiving unit 210 receives an input corresponding to the plaintext M in the first example embodiment. The input receiving unit 210 receives, for example, data entered into the information processing apparatus 200 through an input device such as a keyboard.

Each of the first and second block encryption units 220 and 230 is a hardware circuit that performs the encryption process shown in the first example embodiment. That is, each of the first and second block encryption units 220 and 230 successively performs the above-described processes performed by the first permutation processing unit 120, the second permutation processing unit 130, and termination processing unit 140, and thereby encrypts a 128-bit data string received by the input receiving unit 210. That is, each of the first and second block encryption units 220 and 230 outputs a ciphertext for the input M (i.e., a ciphertext corresponding to the input M). Note that the first and second block encryption units 220 and 230 output two different ciphertexts for the input M (i.e., for the same plaintext). The following descriptions are given on the assumption that the first block encryption unit 220 outputs a first ciphertext X and the second block encryption unit 230 outputs a second ciphertext Y. Note that the first and second block encryption units 220 and 230 may output the different ciphertexts X and Y by using different private keys (different round keys), or may output the different ciphertexts X and Y by performing different nibble permutations. In the case where the first and second block encryption units 220 and 230 perform different nibble permutations, they may use the same private key (the same round key). As described above, the second ciphertext Y may be a ciphertext that is obtained by using a key (a round key) different from the key (the round key) used to generate the first ciphertext X. Alternatively, the second ciphertext Y may be a ciphertext that is obtained by using (i.e., performing) a nibble permutation process 165 in which the bits are rearranged in an arrangement (i.e., an order) different from the arrangement in the nibble permutation process 165 that is used to generate the first ciphertext X.

Note that the different rearrangements in the nibble permutation processes 165 may be the above-described two rearrangements. That is, when indices from 0 to 31 are sequentially assigned to every four bits of the input bit string, and the rearrangement in the nibble permutation process 165 is expressed by the change in the arrangement of these indices, the different rearrangements in the nibble permutation processes 165 may be those described below. The nibble permutation process 165 in which the first arrangement is performed is a rearrangement process in which the arrangement (i.e., the order) of indexes when they are input is (0, 1, . . ., 31) and the arrangement of indexes when they are output is (10, 27, 5, 1, 30, 23, 16, 13, 21, 31, 6, 14, 0, 25, 11, 18, 15, 28, 19, 24, 7, 8, 22, 3, 4, 29, 9, 2, 26, 20, 12, 17). Further, the nibble permutation process 165 in which the second arrangement is performed is a rearrangement process in which the arrangement of indexes when they are input is (0, 1, . . ., 31) and the arrangement of indexes when they are output is (26, 13, 7, 11, 29, 0, 17, 21, 23, 5, 18, 25, 12, 10, 28, 2, 14, 19, 24, 22, 1, 8, 4, 31, 15, 6, 27, 9, 16, 30, 20, 3).

As described above, the first ciphertext X may be a ciphertext that is obtained by performing a first predetermined rearrangement as the nibble permutation process 165, and the second ciphertext Y may be a ciphertext that is obtained by performing a second predetermined rearrangement as the nibble permutation process 165.

The first and second block encryption units 220 and 230 output the first and second ciphertexts X and Y to the addition unit 240.

The addition unit 240 is a hardware circuit that receives the first and second ciphertexts X and Y, adds the first and second ciphertexts X and Y to each other, and outputs the result of the addition as a pseudorandom number. That is, the addition unit 240 generates a pseudorandom number C by adding the first and second ciphertexts X and Y, and outputs the generated pseudorandom number C. In this way, the 128-bit pseudorandom number C is output as the result of the processing performed by the addition unit 240. Note that the above-described addition is, for example, an exclusive disjunction (or exclusive or), but may be an arithmetic addition or the like.

The output control unit 250 is a hardware circuit that performs control for outputting the result of the processing performed by the addition unit 240 to an output device such as a display. That is, the output control unit 250 performs control for outputting the pseudorandom number C to the output device.

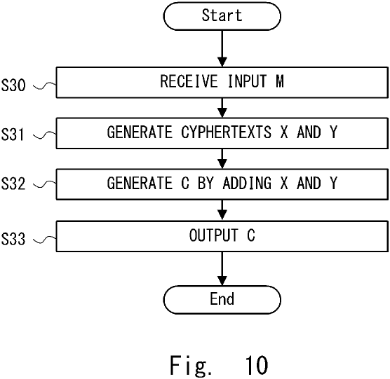

FIG. 10 is a flowchart showing an example of a flow of operations performed by the information processing apparatus 200. The flow of operations performed by the information processing apparatus 200 will be described hereinafter with reference to FIG. 10.

In a step S30, the input receiving unit 210 receives an input M.

Next, in a step S31, the first block encryption unit 220 generates a first ciphertext X and the second block encryption unit 230 generates a second ciphertext Y.

Next, in a step S32, the addition unit 240 adds the first and second ciphertexts X and Y to each other, and thereby generates a pseudorandom number C.

Lastly, in a step S33, the output control unit 250 outputs the bit string obtained in the step S22 to a display or the like as the pseudorandom number C.

In the information processing apparatus 200, two encryption processes described in the first example embodiment are arranged (i.e., performed) in parallel, and their outputs are added to each other, so that a highly-secure pseudorandom function is formed. The aforementioned pseudorandom function disclosed in “Information-theoretic Indistinguishability via the Chi-squared Method” requires two independent keys. In the example embodiment, there is no need to prepare a plurality of keys as long as different nibble permutations are used in respective block cipher processes. In particular, it is possible to ensure the security by selecting two types of nibble permutations that can exhibit excellent performance in terms of the Active S-box as those used in respective block cipher processes.

In the case of 128-bit block cipher like the one shown in the first example embodiment, the amount of data necessary for the birthday attack is O(2^64) blocks, so that the security is significantly improved. However, in consideration of increases in speed and capacity of networks, it is desirable that they can withstand attacks using a larger amount of data when long-term security is required. In this regard, in the case of the pseudorandom function having an input width of 128 bits implemented by the information processing apparatus 200, when it is used in ordinary encryption or in the authentication cipher mode (such as a counter mode or a GCM mode), the amount of data necessary for the attack is O(2^128) blocks. Therefore, it is possible to provide encryption that is secure enough even in the long term.

Note that although the above descriptions have been given on the assumption that the elements shown in FIGS. 2 or 9 are implemented as hardware configurations, they are not limited to such examples. Some or all of these elements can also be implemented by having a processor of a computer execute a computer program.

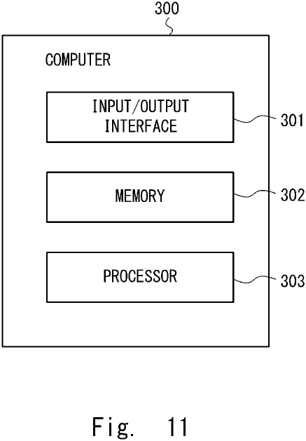

FIG. 11 is a block diagram showing an example of a configuration of a computer 300 that implements the elements shown in FIGS. 2 or 9. As shown in FIG. 11, the computer 300 includes an input/output interface 301, a memory 302, and a processor 303.

The input/output interface 301 is used to communicate with other arbitrary apparatus.

The memory 302 is composed of, for example, a combination of a volatile memory and a nonvolatile memory. The memory 302 is used to store software (a computer program) containing at least one instruction that is executed by the processor 303.

The processor 303 performs a process performed by each of the components shown in FIGS. 2 or 9 by loading the software (the computer program) from the memory 302 and executes the loaded software.

The processor 303 may be, for example, a microprocessor, an MPU (Micro Processor Unit), or a CPU (Central Processing Unit). The processor 303 may include a plurality of processors.

Note that the aforementioned program may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), CD-R, CD-R/W, and a semiconductor memory (such as a mask ROM, a PROM (Programmable ROM), an EPROM (Erasable PROM), a flash ROM, and a RAM (Random Access Memory)). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

Although the present invention is described above with reference to example embodiments, the present invention is not limited to the above-described example embodiments. Various modifications that can be understood by those skilled in the art can be made to the configuration and details of the present invention within the scope of the invention.

The whole or part of the example embodiments disclosed above can be described as, but not limited to, the following Supplementary notes.

### Supplementary Note 1

An information processing apparatus comprising:
input receiving means for receiving an input of a plaintext in which 128 bits are handled as one block;
first permutation processing means for repeating a first permutation process a times (where a is a predetermined integer) in which one block of the plaintext is used as a first input, and thereby outputting a first intermediate text;
second permutation processing means for repeating a second permutation process b times (where b is a predetermined integer) in which the first intermediate text is used as a first input, and thereby outputting a second intermediate text; and
termination processing means for performing a termination process for outputting a ciphertext by using the second intermediate text as an input, wherein
   the first permutation process is a permutation process in which:
      an addition process for adding a round key and a round constant to the input;
      an S-box process for applying, for each nibble, a 4-bit S-box to the input, the 4-bit S-box being a nonlinear function of converting a 4-bit input into a 4-bit output;
      a bit permutation process for rearranging the input on a bit-by-bit basis; and
      a matrix multiplication process for dividing the input, at every four nibbles, into eight words, and applying a 4×4 Almost MDS matrix transformation to each of the words are successively performed,
   the second permutation process is a permutation process in which:
      the addition process;
      the S-box process;
      a nibble permutation process for rearranging the input on a nibble-by-nibble basis; and
      the matrix multiplication process are successively performed, and
   the termination process is a permutation process in which:
      the S-box process; and
      the addition process are successively performed.

### Supplementary Note 2

The information processing apparatus described in Supplementary note 1, wherein
when input 32 nibbles are expressed as X(1), . . ., and X(32); output 32 nibbles are expressed as Y(1), . . ., and Y(32); the output is divided at every four nibbles and is expressed as W(1) = [Y(1), Y(2), Y(3), Y(4)], W(2) = [Y(5), Y(6), Y(7), Y(8)], . . ., and W(8) = [Y(29), Y(30), Y(31), Y(32)]; nibbles to which four bits B(i,1), B(i,2), B(i,3) and B(i,4) of an input X(i) are mapped are represented by Y(a), Y(b), Y(c) and Y(d), respectively (where each of a, b, c and d is an integer no smaller than 1 and no greater 32); and 12 nibbles that are obtained by excluding Y(a), Y(b), Y(c) and Y(d) from W(j) to which the four nibbles belong are represented by Y(j[1]), Y(j[2]), . . ., and Y(j[12]) (where each of j[1], j[2] and j[12] is an integer no smaller than 1 and no greater 32),
the bit permutation process is a process for performing a rearrangement so that a below-described first condition and a second condition are satisfied,

### First Condition

for each i = 1, ..., and 32, all the four bits B(i,1), B(i,2), B(i,3) and B(i,4) of the input X(i) should be mapped to different W(j) (j = 1, ..., and 8), and

### Second Condition

at least two nibbles should be covered in each of W(1), . . ., and W(8) by mapping of 12 nibbles X(j[1]), X(j[2]), . . ., and X(j[12]) of the input, in which positions of the 12 nibbles in inputs X(1), . . ., and X(32) correspond to positions of Y(j[1]), Y(j[2]), and Y(j[12]) in Y(1), . . ., and Y(32).

### Supplementary Note 3

The information processing apparatus described in Supplementary note 1 or 2, wherein the nibble permutation process is a process in which the number of rounds of the nibble permutation process necessary for increasing the number of Active S-boxes to a predetermined value or greater satisfies a predetermined condition.

### Supplementary Note 4

The information processing apparatus described in any one of Supplementary notes 1 to 3, further comprising addition means for receiving a first cipher text and a second ciphertext, adding the first and second ciphertexts to each other, and outputting a result of the addition as a pseudorandom number, the first and second ciphertexts being different ciphertexts for the same plaintext.

### Supplementary Note 5

The information processing apparatus described in Supplementary note 4, wherein
the first ciphertext is a ciphertext obtained by performing a first predetermined rearrangement as the nibble permutation process, and the second ciphertext is a ciphertext obtained by performing a second predetermined rearrangement as the nibble permutation process,
when indices from 0 to 31 are sequentially assigned to every four bits of an input bit string, and the first predetermined rearrangement is expressed by a change in an arrangement of these indices, the nibble permutation process by the first predetermined rearrangement is a process in which an arrangement of the indexes when they are input is (0, 1, . . ., 31) and an arrangement of the indexes when they are output is (10, 27, 5, 1, 30, 23, 16, 13, 21, 31, 6, 14, 0, 25, 11, 18, 15, 28, 19, 24, 7, 8, 22, 3, 4, 29, 9, 2, 26, 20, 12, 17), and
when indices from 0 to 31 are sequentially assigned to every four bits of the input bit string, and the second predetermined rearrangement is expressed by a change in the arrangement of these indices, the nibble permutation process by the second predetermined rearrangement is a process in which the arrangement of the indexes when they are input is (0, 1, . . ., 31) and the arrangement of the indexes when they are output is (26, 13, 7, 11, 29, 0, 17, 21, 23, 5, 18, 25, 12, 10, 28, 2, 14, 19, 24, 22, 1, 8, 4, 31, 15, 6, 27, 9, 16, 30, 20, 3).

### Supplementary Note 6

An information processing method comprising:
receiving an input of a plaintext in which 128 bits are handled as one block;
repeating a first permutation process a times (where a is a predetermined integer) in which one block of the plaintext is used as a first input, and thereby outputting a first intermediate text;
repeating a second permutation process b times (where b is a predetermined integer) in which the first intermediate text is used as a first input, and thereby outputting a second intermediate text; and
performing a termination process for outputting a ciphertext by using the second intermediate text as an input, wherein
   the first permutation process is a permutation process in which:
      an addition process for adding a round key and a round constant to the input;
      an S-box process for applying, for each nibble, a 4-bit S-box to the input, the 4-bit S-box being a nonlinear function of converting a 4-bit input into a 4-bit output;
      a bit permutation process for rearranging the input on a bit-by-bit basis; and
      a matrix multiplication process for dividing the input, at every four nibbles, into eight words, and applying a 4×4 Almost MDS matrix transformation to each of the words are successively performed,
   the second permutation process is a permutation process in which:
      the addition process;
      the S-box process;
      a nibble permutation process for rearranging the input on a nibble-by-nibble basis; and
      the matrix multiplication process are successively performed, and
   the termination process is a permutation process in which:
      the S-box process; and
      the addition process are successively performed.

### Supplementary Note 7

A non-transitory computer readable medium storing a program for causing a computer to perform:
an input receiving step of receiving an input of a plaintext in which 128 bits are handled as one block;
a first permutation processing step of repeating a first permutation process a times (where a is a predetermined integer) in which one block of the plaintext is used as a first input, and thereby outputting a first intermediate text;
a second permutation processing step of repeating a second permutation process b times (where b is a predetermined integer) in which the first intermediate text is used as a first input, and thereby outputting a second intermediate text; and
a termination processing step of performing a termination process for outputting a ciphertext by using the second intermediate text as an input, wherein
   the first permutation process is a permutation process in which:
      an addition process for adding a round key and a round constant to the input;
      an S-box process for applying, for each nibble, a 4-bit S-box to the input, the 4-bit S-box being a nonlinear function of converting a 4-bit input into a 4-bit output;
      a bit permutation process for rearranging the input on a bit-by-bit basis; and
      a matrix multiplication process for dividing the input, at every four nibbles, into eight words, and applying a 4×4 Almost MDS matrix transformation to each of the words are successively performed,
   the second permutation process is a permutation process in which:
      the addition process;
      the S-box process;
      a nibble permutation process for rearranging the input on a nibble-by-nibble basis; and
      the matrix multiplication process are successively performed, and
   the termination process is a permutation process in which:
      the S-box process; and
      the addition process are successively performed.

REFERENCE SIGNS LIST

| | |
|---|---|
| 10 | INFORMATION PROCESSING APPARATUS |
| 11 | INPUT RECEIVING UNIT |
| 12 | FIRST PERMUTATION PROCESSING UNIT |
| 13 | SECOND PERMUTATION PROCESSING UNIT |
| 14 | TERMINATION PROCESSING UNIT |
| 100 | INFORMATION PROCESSING APPARATUS |
| 110 | INPUT RECEIVING UNIT |
| 120 | FIRST PERMUTATION PROCESSING UNIT |
| 130 | SECOND PERMUTATION PROCESSING UNIT |
| 140 | TERMINATION PROCESSING UNIT |
| 150 | OUTPUT CONTROL UNIT |
| 161 | ADDITION PROCESS |
| 162 | S-box PROCESS |
| 163 | BIT PERMUTATION PROCESS |
| 164 | MATRIX MULTIPLICATION PROCESS |
| 165 | NIBBLE PERMUTATION PROCESS |
| 170 | S-box |
| 171 | MATRIX |
| 200 | INFORMATION PROCESSING APPARATUS |
| 210 | INPUT RECEIVING UNIT |
| 220 | FIRST BLOCK ENCRYPTION UNIT |
| 230 | SECOND BLOCK ENCRYPTION UNIT |
| 240 | ADDITION UNIT |
| 250 | OUTPUT CONTROL UNIT |
| 300 | COMPUTER |
| 301 | INPUT/OUTPUT INTERFACE |
| 302 | MEMORY |
| 303 | PROCESSOR |

1. An information processing apparatus comprising:
an input receiving circuit configured to receive an input of a plaintext in which 128 bits are handled as one block;
a first permutation processing circuit configured to repeat a first permutation process a times (where a is a predetermined integer) in which one block of the plaintext is used as a first input, and thereby output a first intermediate text;
a second permutation processing circuit configured to repeat a second permutation process b times (where b is a predetermined integer) in which the first intermediate text is used as a first input, and thereby output a second intermediate text; and
a termination processing circuit configured to perform a termination process for outputting a ciphertext by using the second intermediate text as an input, wherein
the first permutation process is a permutation process in which:
an addition process for adding a round key and a round constant to the input;
an S-box process for applying, for each nibble, a 4-bit S-box to the input, the 4-bit S-box being a nonlinear function of converting a 4-bit input into a 4-bit output;
a bit permutation process for rearranging the input on a bit-by-bit basis; and
a matrix multiplication process for dividing the input, at every four nibbles, into eight words, and applying a 4×4 Almost MDS matrix transformation to each of the words are successively performed,
the second permutation process is a permutation process in which:
the addition process;
the S-box process;
a nibble permutation process for rearranging the input on a nibble-by-nibble basis; and
the matrix multiplication process are successively performed, and
the termination process is a permutation process in which:
the S-box process; and
the addition process are successively performed.

2. The information processing apparatus according to claim 1, wherein
when input 32 nibbles are expressed as X(1),..., and X(32); output 32 nibbles are expressed as Y(1),..., and Y(32); the output is divided at every four nibbles and is expressed as W(1) = [Y(1), Y(2), Y(3), Y(4)], W(2) = [Y(5), Y(6), Y(7), Y(8)], ..., and W(8) = [Y(29), Y(30), Y(31), Y(32)]; nibbles to which four bits B(i,1), B(i,2), B(i,3) and B(i,4) of an input X(i) are mapped are represented by Y(a), Y(b), Y(c) and Y(d), respectively (where each of a, b, c and d is an integer no smaller than 1 and no greater 32); and 12 nibbles that are obtained by excluding Y(a), Y(b), Y(c) and Y(d) from W(j) to which the four nibbles belong are represented by Y(j[1]), Y(j[2]),..., and Y(j[12]) (where each of j[1], j[2] and j[12] is an integer no smaller than 1 and no greater 32),
the bit permutation process is a process for performing a rearrangement so that a belowdescribed first condition and a second condition are satisfied,
(First Condition)
for each i = 1,..., and 32, all the four bits B(i,1), B(i,2), B(i,3) and B(i,4) of the input X(i) should be mapped to different W(j) (j = 1,..., and 8), and
(Second Condition)
at least two nibbles should be covered in each of W(1),..., and W(8) by mapping of 12 nibbles X(j[1]), X(j[2]),..., and X(j[12]) of the input, in which positions of the 12 nibbles in inputs X(1),..., and X(32) correspond to positions of Y(j[1]), Y(j[2]),..., and Y(j[12]) in Y(1),..., and Y(32).

3. The information processing apparatus according to claim 1, wherein the nibble permutation process is a process in which the number of rounds of the nibble permutation process necessary for increasing the number of Active S-boxes to a predetermined value or greater satisfies a predetermined condition.

4. The information processing apparatus according to claim 1, further comprising an addition circuit configured to receive a first cipher text and a second ciphertext, add the first and second ciphertexts to each other, and output a result of the addition as a pseudorandom number, the first and second ciphertexts being different ciphertexts for the same plaintext.

5. The information processing apparatus according to claim 4, wherein
the first ciphertext is a ciphertext obtained by performing a first predetermined rearrangement as the nibble permutation process, and the second ciphertext is a ciphertext obtained by performing a second predetermined rearrangement as the nibble permutation process,
when indices from 0 to 31 are sequentially assigned to every four bits of an input bit string, and the first predetermined rearrangement is expressed by a change in an arrangement of these indices, the nibble permutation process by the first predetermined rearrangement is a process in which an arrangement of the indexes when they are input is (0, 1,..., 31) and an arrangement of the indexes when they are output is (10, 27, 5, 1, 30, 23, 16, 13, 21, 31, 6, 14, 0, 25, 11, 18, 15, 28, 19, 24, 7, 8, 22, 3, 4, 29, 9, 2, 26, 20, 12, 17), and
when indices from 0 to 31 are sequentially assigned to every four bits of the input bit string, and the second predetermined rearrangement is expressed by a change in the arrangement of these indices, the nibble permutation process by the second predetermined rearrangement is a process in which the arrangement of the indexes when they are input is (0, 1,..., 31) and the arrangement of the indexes when they are output is (26, 13, 7, 11, 29, 0, 17, 21, 23, 5, 18, 25, 12, 10, 28, 2, 14, 19, 24, 22, 1, 8, 4, 31, 15, 6, 27, 9, 16, 30, 20, 3).

6. An information processing method comprising:
receiving an input of a plaintext in which 128 bits are handled as one block;
repeating a first permutation process a times (where a is a predetermined integer) in which one block of the plaintext is used as a first input, and thereby outputting a first intermediate text;
repeating a second permutation process b times (where b is a predetermined integer) in which the first intermediate text is used as a first input, and thereby outputting a second intermediate text; and
performing a termination process for outputting a ciphertext by using the second intermediate text as an input, wherein
the first permutation process is a permutation process in which:
an addition process for adding a round key and a round constant to the input;
an S-box process for applying, for each nibble, a 4-bit S-box to the input, the 4-bit S-box being a nonlinear function of converting a 4-bit input into a 4-bit output;
a bit permutation process for rearranging the input on a bit-by-bit basis; and
a matrix multiplication process for dividing the input, at every four nibbles, into eight words, and applying a 4×4 Almost MDS matrix transformation to each of the words are successively performed,
the second permutation process is a permutation process in which:
the addition process;
the S-box process;
a nibble permutation process for rearranging the input on a nibble-by-nibble basis; and
the matrix multiplication process are successively performed, and
the termination process is a permutation process in which:
the S-box process; and
the addition process are successively performed.

7. A non-transitory computer readable medium storing a program for causing a computer to perform:
an input receiving step of receiving an input of a plaintext in which 128 bits are handled as one block;
a first permutation processing step of repeating a first permutation process a times (where a is a predetermined integer) in which one block of the plaintext is used as a first input, and thereby outputting a first intermediate text;
a second permutation processing step of repeating a second permutation process b times (where b is a predetermined integer) in which the first intermediate text is used as a first input, and thereby outputting a second intermediate text; and
a termination processing step of performing a termination process for outputting a ciphertext by using the second intermediate text as an input, wherein
the first permutation process is a permutation process in which:
an addition process for adding a round key and a round constant to the input;
an S-box process for applying, for each nibble, a 4-bit S-box to the input, the 4-bit S-box being a nonlinear function of converting a 4-bit input into a 4-bit output;
a bit permutation process for rearranging the input on a bit-by-bit basis; and
a matrix multiplication process for dividing the input, at every four nibbles, into eight words, and applying a 4×4 Almost MDS matrix transformation to each of the words are successively performed,
the second permutation process is a permutation process in which:
the addition process;
the S-box process;
a nibble permutation process for rearranging the input on a nibble-by-nibble basis; and
the matrix multiplication process are successively performed, and
the termination process is a permutation process in which:
the S-box process; and
the addition process are successively performed.
